(19) United States
(12) Patent Application Publication
(10) Pub. No.: US 2009/0137149 A1
(43) Pub. Date: May 28, 2009

(54) CONNECTOR MODULE

(76) Inventor: Stephen James Morris, Cheltenham (GB)

Correspondence Address: MERCHANT & GOULD PC, P.O. BOX 2903, MINNEAPOLIS, MN, 55402-0903, US

(21) Appl. No.: 12/236,655

(22) Filed: Sep. 24, 2008

Related U.S. Application Data
(60) Provisional application No. 60/975,368, filed on Sep. 26, 2007.

(51) Int. Cl. H01R 13/73; H01R 24/00

(52) U.S. Cl. 439/553; 439/676

(57) ABSTRACT

A connector module includes a bracket and a housing. The bracket includes a top end portion having a resilient latch with a free end portion and a protrusion outwardly extending from the free end portion and a bottom end portion defining a gap between a base of the bracket and a ridge of the bracket. The housing includes a front wall having a plurality of connector openings, a first end that extends outwardly from the front wall, and an oppositely disposed second end that extends outwardly from the front wall. The first end includes a lip that is configured to be selectively received in the gap of the bracket. The second end defines a cavity that is adapted to selectively receive the protrusion of the resilient latch. The housing further includes a plurality of identification areas disposed on the front wall adjacent to the connector openings.

### CROSS REFERENCE TO RELATED APPLICATIONS

This application claims the benefit of U.S. Provisional Patent Application Ser. No. 60/975,368, filed Sep. 26, 2007, which is hereby incorporated by reference in its entirety.

### BACKGROUND

Many indoor facilities such as business offices and residential homes include preinstalled service access points through which connections to telecommunication networks can be established. However, as telecommunication networks continue to expand, there becomes a need for additional service access points in a facility.

### SUMMARY

An aspect of the present disclosure relates to a connector module having a bracket and a housing. The bracket includes a top end portion having a resilient latch with a free end portion and a protrusion outwardly extending from the free end portion and a bottom end portion defining a gap between a base of the bracket and a ridge of the bracket. The housing includes a front wall having a plurality of connector openings, a first end that extends outwardly from the front wall, and an oppositely disposed second end that extends outwardly from the front wall. The first end includes a lip that is configured to be selectively received in the gap of the bracket. The second end defines a cavity that is adapted to selectively receive the protrusion of the resilient latch. The housing further includes a plurality of identification areas disposed on the front wall adjacent to the connector openings.

A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### DESCRIPTION OF THE DRAWINGS

FIG. 1 is a perspective view of a connector module having features that are examples of aspects in accordance with the principles of the present disclosure.

FIG. 2 is a perspective view of the connector module of FIG. 1 with a housing partially disengaged from a bracket.

FIG. 3 is a perspective view of the housing of FIG. 2.

FIG. 4 is a perspective view of a front portion of the housing of FIG. 3.

FIG. 5 is a perspective view of the front portion of the housing of FIG. 3.

FIG. 6 is a perspective view of the front portion of the housing of FIG. 3.

FIG. 7 is a perspective view of the front portion of the housing of FIG. 3.

FIG. 8 is an exploded perspective view of the front face of the housing of FIG. 3.

FIG. 9 is a perspective view of the connector module of FIG. 1 with the housing partially disengaged from the bracket.

FIG. 10 is a perspective view of the bracket of FIG. 1.

FIG. 11 is an perspective view of the bracket of FIG. 1.

FIG. 12 is a schematic representation of the use of the connector module of FIG. 1 in a room.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

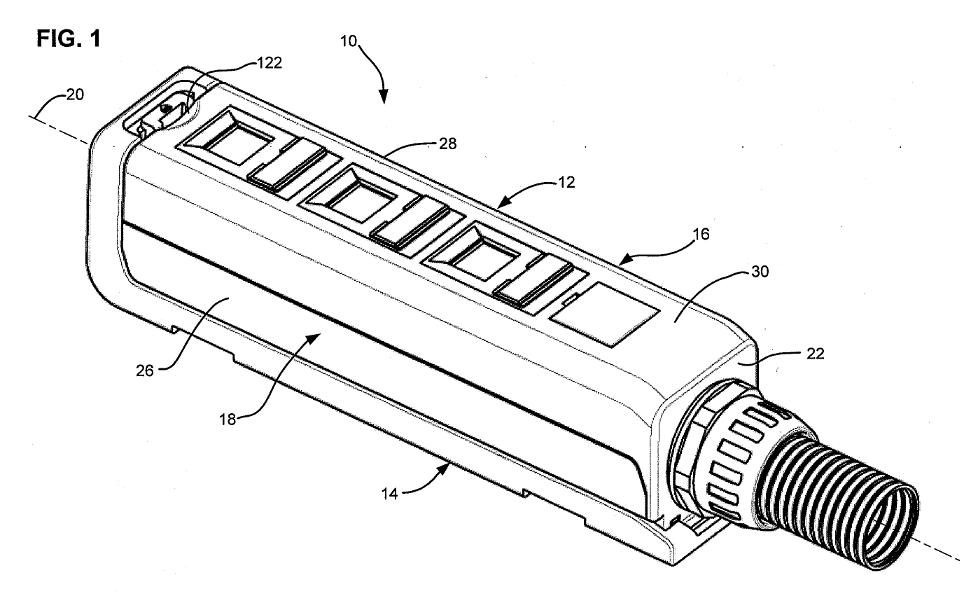

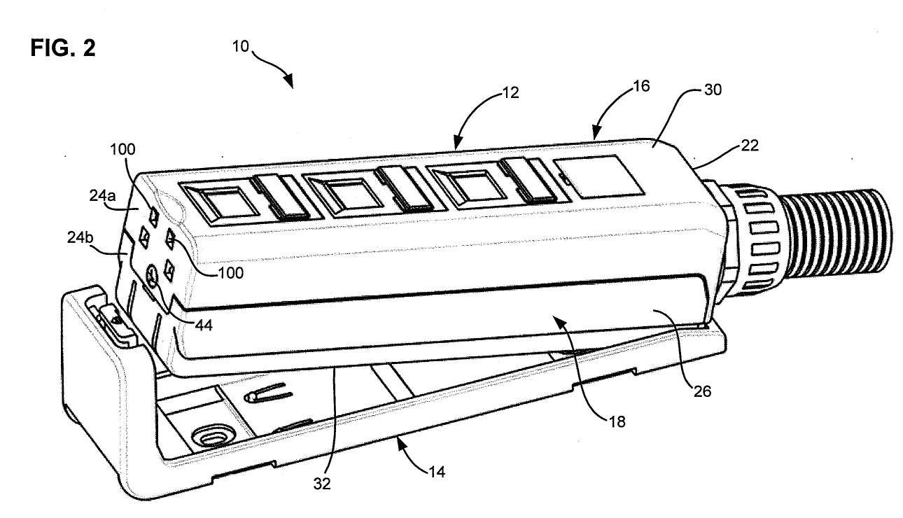

Referring now to FIGS. 1 and 2, a connector module, generally designated 10, is shown. In the subject embodiment, the connector module 10 includes a housing, generally designated 12, and a bracket 14.

The housing 12 is generally rectangular in shape and includes a front portion, generally designated 16, connectedly engaged with a rear portion, generally designated 18. The housing 12 defines a longitudinal axis 20 (shown as a dashed line in FIG. 1) that extends axially through the length of the housing 12.

The housing 12 includes a first end 22 and an oppositely disposed second end 24 (best shown in FIG. 2). The first and second ends 22, 24 are generally perpendicular to the longitudinal axis 20. It will be understood, however, that the scope of the present disclosure is not limited to the first and second ends 22, 24 being generally perpendicular to the longitudinal axis 20. In the subject embodiment, the first end 22 of the housing 12 is defined by the front portion 16 of the housing 12 while the second end 24 of the housing is cooperatively defined by second ends 24a, 24b of the front and rear portions 16, 18, respectively. The housing 12 further includes a left sidewall 26, a right sidewall 28, a front wall 30, and a back wall 32 (best shown in FIG. 2). In the subject embodiment, the left and right sidewalls 26, 28 and the front and back walls 30, 32 are generally parallel to the longitudinal axis 20.

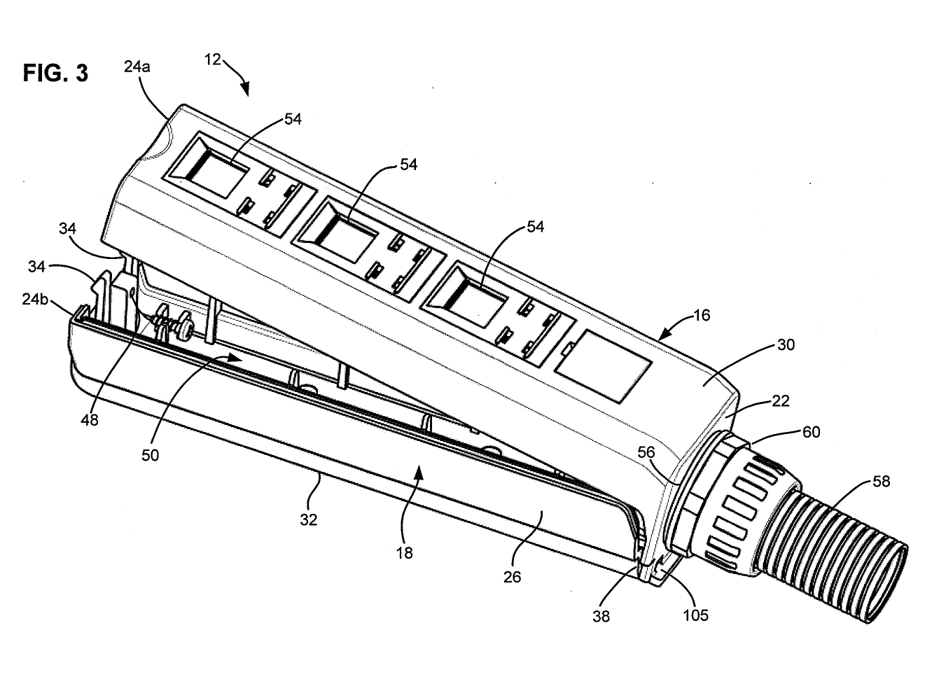

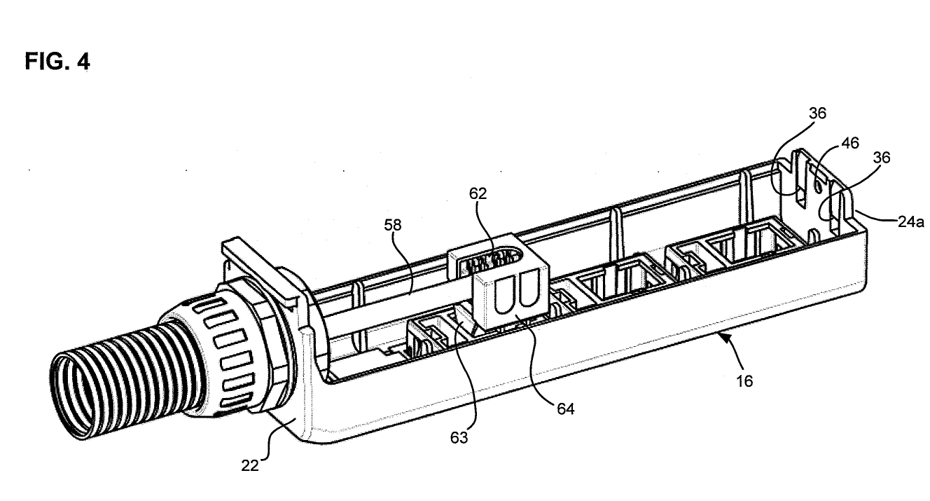

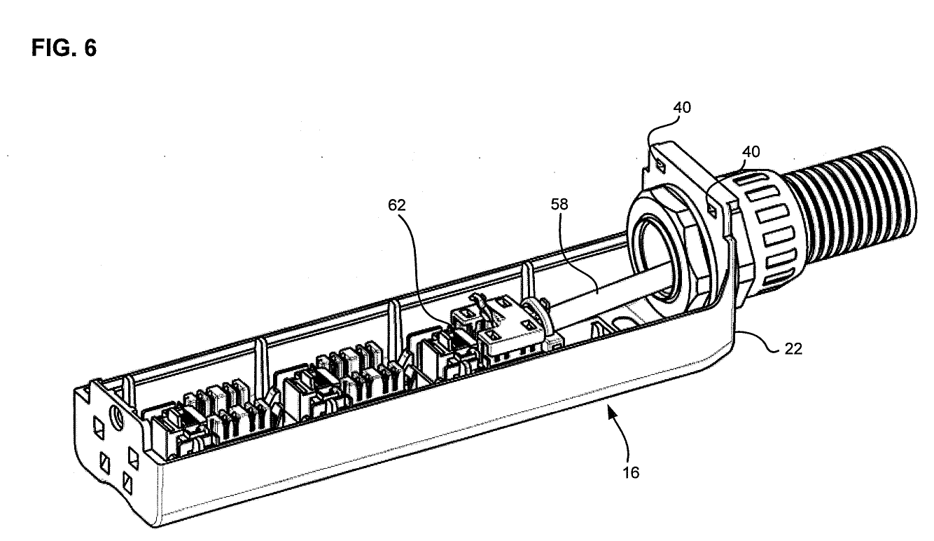

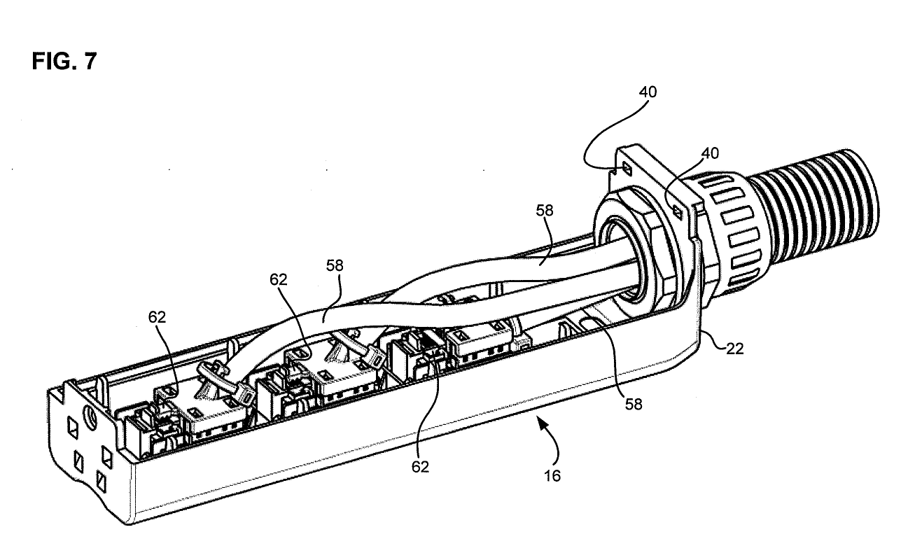

Referring now to FIG. 3, the front and rear portions 16, 18 of the housing 12 are connectedly engaged by a plurality of latches 34 and a plurality of tabs. In the subject embodiment, the latches 34 are disposed on second end 24b of the rear portion 18 of the housing 12 such that the latches 34 extend outwardly in a direction that is generally perpendicular to the back wall 32. The second end 24a of the front portion 16 of the housing 12 includes a plurality of catches 36 (shown in FIG. 4) that are adapted to receive the latches 34 in a snap-fit engagement. The plurality of tabs is disposed on a first end portion 38 of the rear portion 18 of the housing 12. The tabs are adapted for engagement with a plurality of recesses 40 (shown only in FIGS. 6 and 7) in the first end 22 of the front portion 16. The engagement between the tabs of the rear portion 18 and the recesses 40 of the front portion 16 prevent the first end 22 of the front portion 16 from becoming disengaged with the first end portion 38 of the rear portion 18 during assembly of the housing 12.

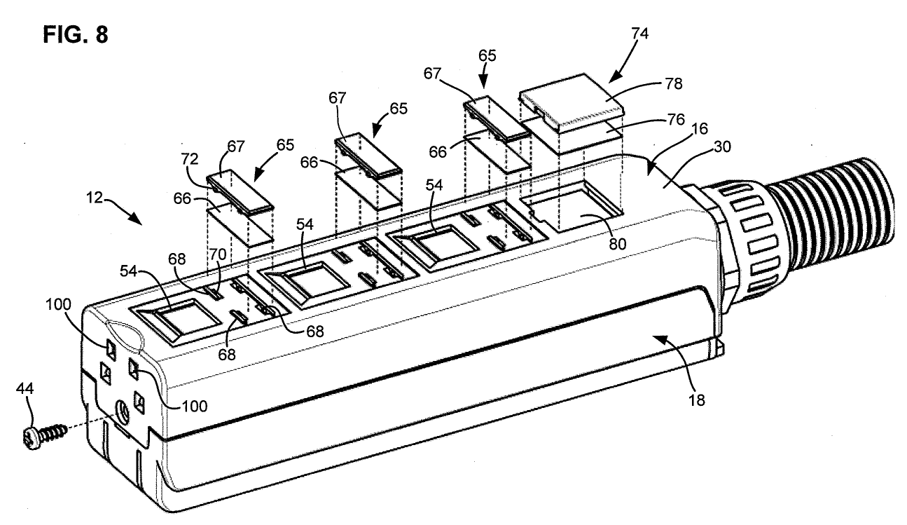

In the subject embodiment, the front and rear portions 16, 18 of the housing 12 are further secured together by a fastener 44 (shown in FIGS. 2 and 8), such as a bolt, screw, rivet, etc. The fastener 44 extends through a hole 46 (shown in FIG. 4) in the second end 24a of the front portion 16 and through an opening 48 in the second end 24b of the rear portion 18. In the subject embodiment, the fastener 44 is in threaded engagement with the opening 48 in the second end 24b of the rear portion 18.

The front and rear portions 16, 18 of the housing 12 cooperatively define an interior region 50. Disposed in the interior region 50 is at least one connector jack 62, which will be subsequently described.

The front portion 16 of the housing 12 defines a plurality of connector openings 54 disposed on the front wall 30 that open into the interior region 50. In the subject embodiment, the connector openings 54 are arranged generally along the longitudinal axis 20 of the housing 12. In the subject embodiment, and by way of example only, there are three connector openings 54 defined by the front wall 30 of the front portion 16 of the housing 12.

The front portion 16 of the housing 12 further defines a cable opening 56 disposed generally in the center of the first end 22. The cable opening 56 is adapted to receive a cable 58 and a retention member 60 for retaining the cable 58 in the cable opening 56. In one embodiment, the cable 58 is a fiber optic cable. In another embodiment, the cable 58 is a copper cable.

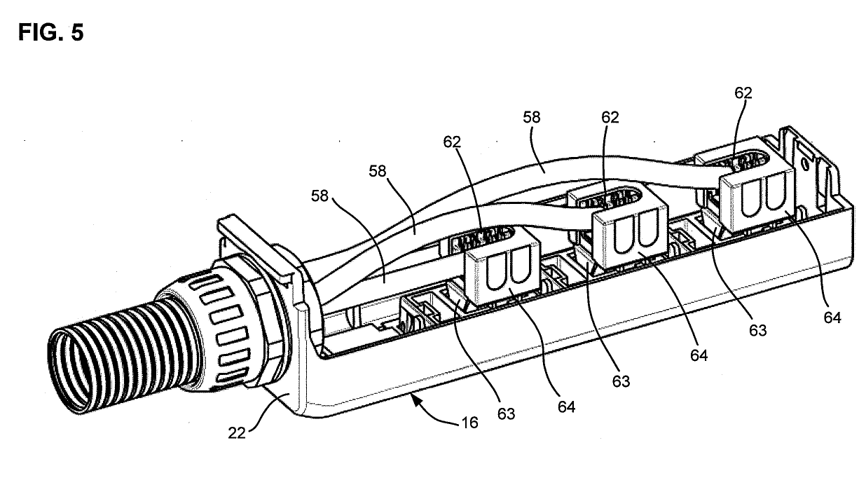

Referring now to FIGS. 4-7, at least one connector jack 62 is engaged with one of the connector openings 54. In the embodiments shown in FIGS. 4 and 6, one connector jack 62 is engaged with one of the plurality of connector openings 54. In the embodiments shown in FIGS. 5 and 7, a connector jack 62 is engaged with each of the connector openings 54.

In the embodiments shown in FIGS. 4-7, the connector jack 62 is of a type that was described in U.S. Pat. No. 7,270,563 and hereby incorporated by reference. In the subject embodiment, the connector jack 62 includes latches 63 that are in snap-fit engagement with the connector opening 54.

The cable 58 is in electrical connection with a back side of the connector jack 62. In the subject embodiment, the electrical connection is established through a plurality of insulation displacement connectors (IDCs). A front side of the connector jack 62 is accessible through the connector opening 54 in the front wall 30 of the housing 12. In the embodiments shown in FIGS. 4-7, the front side of the connector jack 62 is adapted to receive an RJ45 style plug. In another embodiment, the front side of the connector jack 62 is adapted to receive an RJ11 style plug. It will be understood, however, that the scope of the present disclosure is not limited to the connector jack 62 being adapted to receive an RJ45 style plug or an RJ11 style plug.

In the embodiments shown in FIGS. 4 and 5, a termination cap 64, which is described in U.S. Pat. No. 7,232,340 and hereby incorporated by reference, is configured to be mounted on the connector jack 62. Preferably, the termination cap 64 is of a conductive material that is not grounded. An ungrounded conductive termination cap 64 can function to block or at least disrupt alien crosstalk signals.

Referring now to FIG. 8, identification areas, generally designated 65, are disposed on the front portion 16 of the housing 12 such that each identification area 65 is adjacent to a connector opening 54. The identification areas 65 allow for any relevant information related to a particular connector opening 54 to be stored on the housing 12.

In the subject embodiment, the identification areas 65 include an identification tag 66 and an identification window 67. The identification tag 66 is a writing/printing surface, which can be made from a variety of materials such as paper, plastic, etc. The identification window 67 is made from a transparent/translucent material such as clear plastic, glass, etc.

The identification area 65 further includes a plurality of ridges 68 that aid in the retention of the identification tag 66 and the identification window 67. In the subject embodiment, the ridges 68 are disposed on the front wall 30 of the front portion 16 of the housing 12. The front wall 30 also includes tab openings 70 that are adapted to receive tabs 72 disposed about the perimeter of the identification window 67. In the subject embodiment, the tabs 72 are in snap-fit engagement with the tab openings 70.

A secondary information area, generally designated 74, is also disposed on the front wall 30 of the front portion 16 of the housing 12. The secondary information area 74 can be used to store additional information such as information that is related to the service provider. The secondary information area 74 includes an information tag 76 and an information window 78. The information tag 76 is a writing/printing surface, which can be made from a variety of materials such as paper, plastics, etc. The information window 78 is made from a transparent/translucent material such as clear plastic, glass, etc. The information window 78 is adapted for snap-fit engagement with a window cavity 80 defined by the front wall 30 of the housing 12.

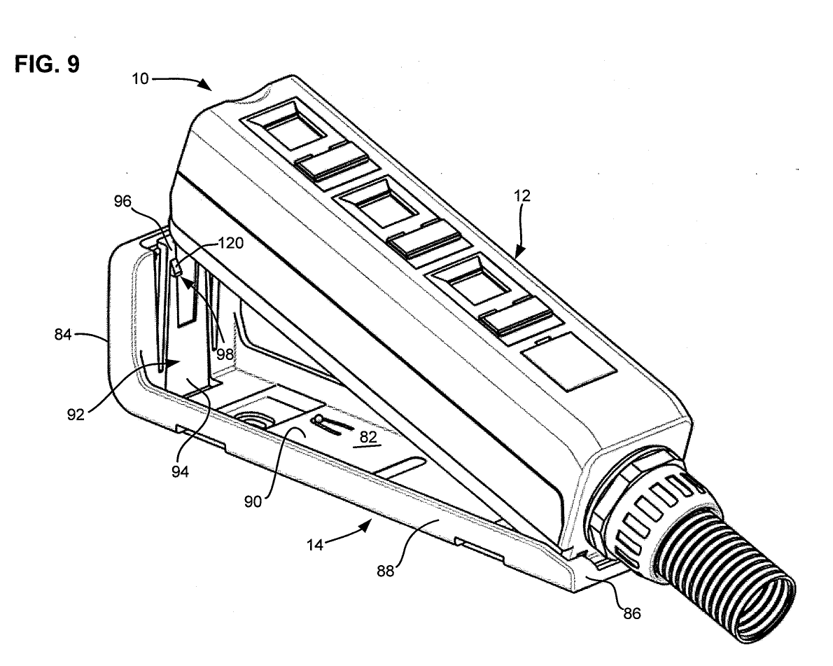

Referring now to FIG. 9, the bracket 14 will be described. The bracket 14 includes a base 82, a top end portion 84, an oppositely disposed bottom end portion 86, and sidewalls 88 that extend between the top end portion 84 and the bottom end portion 86. In the subject embodiment, the top end portion 84, the bottom end portion 86, and the sidewalls 88 extend outwardly in a generally perpendicular direction relative to the base 82. The base 82, the top end portion 84, the bottom end portion 86, and the sidewalls 88 cooperate to define an interior cavity 90.

The top end portion 84 of the bracket 14 includes a resilient latch, generally designated 92. In the subject embodiment, the resilient latch 92 includes a base end portion 94, which is in connected engagement with the base 82, and an oppositely disposed free end portion 96. The free end portion 96 includes at least one protrusion 98. In the subject embodiment, and by way of example only, the free end portion 96 includes two protrusions 98. The protrusions 98 extend outwardly from the free end portion 96 in a direction toward the bottom end portion 86. The protrusions 98 are adapted for selective engagement with a plurality of cavities 100 (shown in FIGS. 2 and 8) defined by the second end 24 of the housing 12. In the subject embodiment, the second end 24a of the front portion 16 of the housing 12 defines the cavities 100. The selective engagement between the protrusions 98 of the resilient latch 92 of the bracket 14 and the cavities 100 of the housing 12 assist in retaining the housing 12 in the bracket 14.

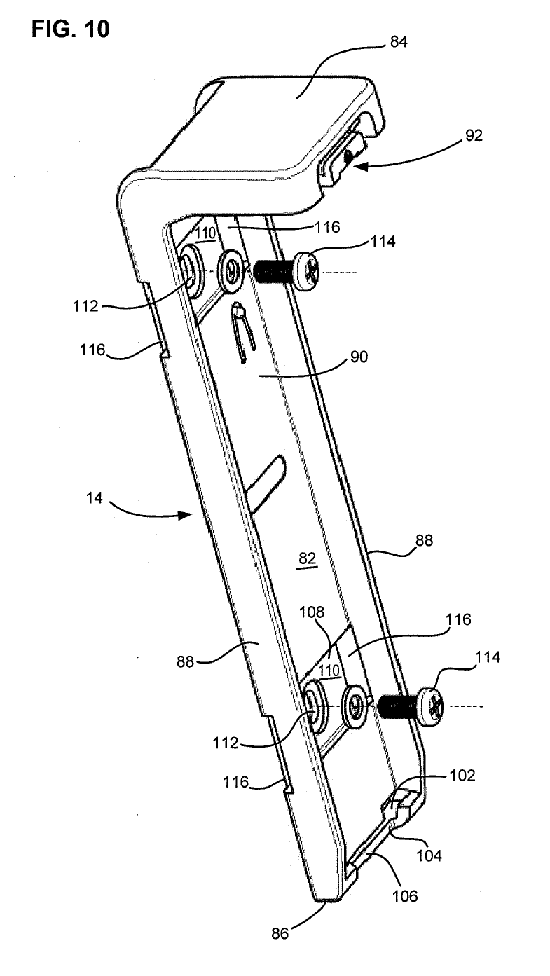

Referring now to FIG. 10, the bottom end portion 86 of the bracket 14 defines a gap 102 between a ridge 104 of the bottom end portion 86 and the base 82. The gap 102 is adapted to receive a lip 105 (best shown in FIG. 3) that is disposed on the first end 22 of the housing 12 such that the lip 105 of the housing 12 is retained between the base 82 of the bracket 14 and the ridge 104.

The bottom end portion 86 of the bracket 14 further defines a cable cavity 106. The cable cavity 106 is a recessed area that provides clearance between the cable 58 and the retention member 60, which are both engaged with the housing 12 and the bracket 14 when the housing 12 is engaged in the bracket 14.

The base 82 of the bracket 14 includes at least one surface mounting area 108. In the subject embodiment, and by way of example only, the bracket 14 includes two surface mounting areas 108. In the subject embodiment, the configuration of the surface mounting area 108 allows for various mounting options in mounting the bracket 14 to a mounting surface, such as a wall, a leg of furniture, or a pole. Each surface mounting area 108 includes a recessed surface 110 that is recessed relative to the base 82. The recessed surface 110 defines a mounting hole 112, which is disposed generally in the center of the recessed surface 110. The mounting hole 112 is adapted to receive a fastener 114 for fastening the bracket 14 to the mounting surface.

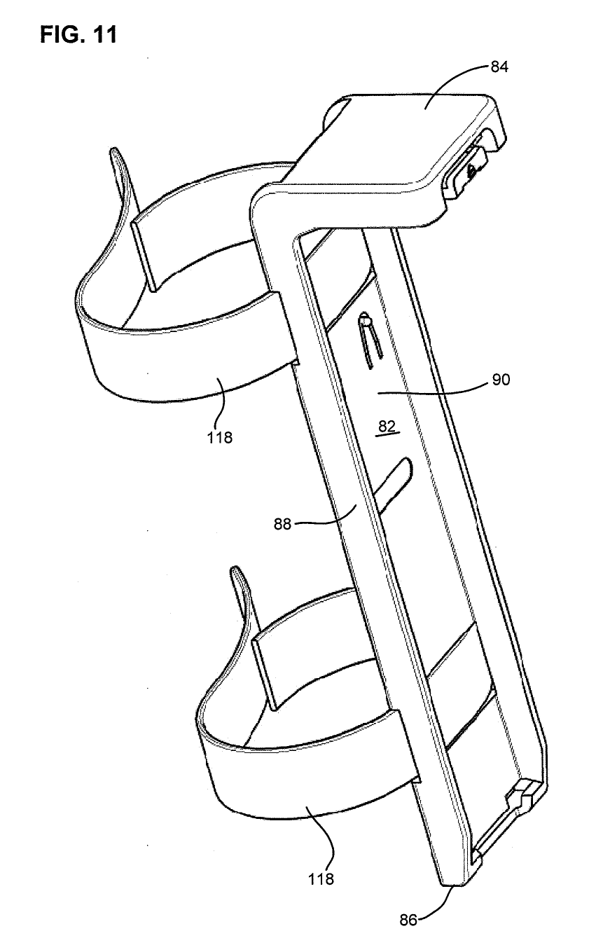

Referring now to FIGS. 10 and 11, the recessed surface 110 and the sidewalls 88 cooperatively define a plurality of strap openings 116. The strap openings 116 are adapted to receive a strap 118, such as a hook and loop strap for fastening the bracket 14 to the mounting surface. The strap 118 provides a mounting option that does not require the use of tools. The strap 118 enters the interior cavity 90 through one of the strap openings 116 and passes over the recessed surface 110. The strap 118 then exits the interior cavity 90 through the other strap opening 116 and wraps around the mounting surface. As previously mentioned, the recessed surface 110 is recessed relative to the base 82. This recess allows for clearance between the straps 118 and the back wall 32 of the housing 12 when the housing 12 is inserted into the bracket 14.

Referring now to FIGS. 3, 9, and 10, a method for connectedly engaging the housing 12 to the bracket 14 will be described. With the bracket 14 mounted to the mounting surface, the lip 105 of the housing 12 is inserted into the gap 102 such that the lip 105 is disposed between the base 82 and the ridge 104. The housing 12 is then pushed back into the bracket 14. As the housing 12 is pushed back into the bracket 14, sloped surfaces 120 (shown in FIG. 9) of the protrusions 98 of the resilient latch 92 engage the second end 24b of the rear portion 18. As the sloped surfaces 120 engage the second end 24b of the rear portion 18, the free end portion 96 of the resilient latch 92 moves away from the second end 24 of the housing 12 until the housing 12 is in proper placement with respect to the bracket 14. When the housing 12 is in proper placement with respect to the bracket 14, the protrusions 98 snap into engagement with the cavities 100 defined by the second end 24a of the front portion 16 of the housing 12. The engagement between the protrusions 98 and the cavities 100 produces an audible snap or click to notify the installer that the housing 12 is properly positioned with respect to the bracket 14.

At any point prior to, during, or following installation, the identification tags 66 can be written/printed and installed in the identification area 65 on the front wall 30 of the front portion 16 of the housing 12. With the identification tags 66 in the proper location, the identification windows 67 can be engaged with the front wall 30 of the housing 12 by engaging the tabs 72, which are disposed around the perimeter of the identification window 67, in the tab openings 70 on the front wall 30. The secondary information tag 76 can also be written/printed and installed in the secondary information area 74.

Referring now to FIGS. 1, 9, and 10, a method for disengaging the housing 12 from the bracket 14 will be described. The housing 12 includes a dimple 122 (shown in FIG. 1) for accessing the free end portion 96 of the resilient latch 92. Using a thumb, finger or tool, the free end portion 96 of the resilient latch 92 can be pushed away from the second end 24 of the housing 12 until the protrusions 98 of the resilient latch 92 disengage the cavities 100 defined by the second end 24 of the housing 12. With the protrusions 98 disengaged from the cavities 100, the housing 12 can be pulled away from the bracket 14 until the second end 24 clears the top end portion 84 of the bracket 14 (as shown in FIG. 9). The free end portion 96 of the resilient latch 92 can be released anytime during movement of the housing 12 away from the bracket 14. With the second end 24 of the housing 12 pulled away from the top end portion 84 of the bracket 14, the lip 105 can be disengaged from the gap 102 in the bottom end portion 86 of the bracket 14.

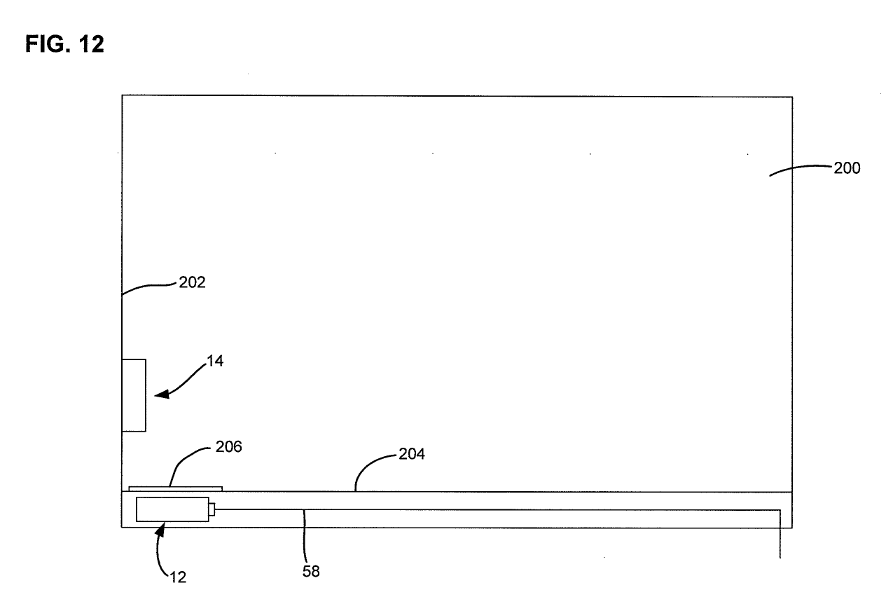

Referring now to FIG. 12, a schematic representation related to the use of the connector module 10 is shown. In a preferred embodiment, the connector module 10 is used in an indoor location, such as a room 200 having a plurality of walls 202 and a floor 204. In the subject embodiment, the room 200 has a plurality of preinstalled service access points for connecting to a service provider. In the event that additional service access points are needed, the connector module 10 can be installed.

The bracket 14 is mounted to one of the walls 202. The bracket 14 can be mounted to the wall 202 before or after the additional service access points are needed. Disposed beneath the floor 204 is the housing 12 which is in connected engagement with the cable 58 from the service provider. When additional service access is needed, the housing 12 is pulled through an access panel 206 in the floor 204 and connectedly engaged with the bracket 14.

The connector module of the subject embodiment provides a number of potential advantages. One potential advantage of the connector module 10 is that the bracket 14 includes the surface mounting area 108 rather than the housing 12. This allows for the housing 12 to be compact, which allows for greater accessibility through small openings in the floor 204.

Another potential advantage of the connector module 10 is that the housing 12 can be mounted to and removed from a surface such as a wall 202 without having to open the housing 12. This allows the connections inside the interior region 50 of the housing 12 to remain undisturbed.

Various modifications and alterations of this disclosure will become apparent to those skilled in the art without departing from the scope and spirit of this disclosure, and it should be understood that the scope of this disclosure is not to be unduly limited to the illustrative embodiments set forth herein.

What is claimed is:

1. A connector module, comprising:
a bracket having:
a base;
a top end portion extending outwardly from the base, wherein the top end portion includes a resilient latch having a free end portion with a protrusion extending outwardly from the free end portion;
a bottom end portion oppositely disposed from the top end portion and extending outwardly from the base, wherein the bottom end portion defines a gap between the base and a ridge of the bottom end portion;
a housing having:
a front wall that defines a plurality of connector openings;
a first end outwardly extended from the front wall, wherein the first end includes a lip that is configured to be selectively received in the gap of the bracket;
a second end oppositely disposed from the first end and outwardly extended from the front wall, wherein the second end defines a cavity that is adapted to selectively receive the protrusion of the resilient latch; and
a plurality of identification areas disposed on the front wall of the housing.

2. A connector module as claimed in claim 1, wherein the housing defines an interior region with a connector jack disposed in the interior region, the connector jack being accessible through one of the connector openings in the front wall of the housing.

3. A connector module as claimed in claim 2, wherein the connector jack is in engagement with one of the plurality of connector openings.

4. A connector module as claimed in claim 3, wherein the connector jack includes latches that are in snap-fit engagement with the front wall.

5. A connector module as claimed in claim 2, wherein the connector jack is adapted to receive an RJ45 style plug.

6. A connector module as claimed in claim 1, wherein each identification area includes an identification tag and an identification window.

7. A connector module as claimed in claim 6, wherein the housing further includes a secondary information area disposed on the front wall of the housing, the secondary information area including an identification tag and an identification window.

8. A connector module as claimed in claim 1, wherein the base defines a plurality of strap openings that are adapted to receive a strap for fastening the bracket to a mounting structure.

9. A connector module as claimed in claim 1, wherein the housing defines a dimple that provides access to the free end portion of the resilient latch of the bracket.

10. A method for engaging a housing of a connector module to a bracket, the method comprising:
providing a housing having:
a front wall that defines a plurality of connector openings;
a first end outwardly extended from the front wall, wherein the first end includes a lip;
a second end oppositely disposed from the first end and outwardly extended from the front wall, wherein the second end defines a cavity;
providing a bracket having:
a base;
a top end portion extending outwardly from the base, wherein the top end portion includes a resilient latch having a free end portion with a protrusion extending outwardly from the free end portion;
a bottom end portion oppositely disposed from the top end portion and extending outwardly from the base, wherein the bottom end portion defines a gap between the base and a ridge of the bottom end portion;
inserting the lip of the housing into the gap of the bottom end portion of the bracket;
pushing the housing toward the bracket so that the protrusion of the resilient latch engages the cavity of the second end of the housing.

11. A method for engaging a housing of a connector module to a bracket as claimed in claim 10, further comprising providing notification that the housing is properly positioned with respect to the bracket.

12. A method for engaging a housing of a connector module to a bracket as claimed in claim 11, wherein the notification is an audible click produced by the engagement of the protrusion and the cavity.

13. A method for engaging a housing of a connector module to a bracket as claimed in claim 10, wherein the bracket is mounted to a mounting structure by straps.

14. A method for engaging a housing of a connector module to a bracket as claimed in claim 10, wherein the housing defines an interior region with a connector jack disposed in the interior region, the connector jack being accessible through one of the connector openings in the front wall of the housing.

15. A method for engaging a housing of a connector module to a bracket as claimed in claim 10, wherein the housing includes a plurality of identification areas disposed on the front wall of the housing.

16. A method for disengaging a housing of a connector module from a bracket, the method comprising:
providing a connector module having:
a bracket having:
a base;
a top end portion extending outwardly from the base, wherein the top end portion includes a resilient latch having a free end portion with a protrusion extending outwardly from the free end portion;
a bottom end portion oppositely disposed from the top end portion and extending outwardly from the base, wherein the bottom end portion defines a gap between the base and a ridge of the bottom end portion;
a housing engaged with a bracket, the housing having
a front wall that defines a plurality of connector openings;
a first end outwardly extending from the front wall and including a lip, wherein the lip is disposed in the gap of the bracket;
a second end oppositely disposed from the first end and outwardly extended from the front wall and defining a cavity, wherein the protrusion of the resilient latch of the bracket is disposed in the cavity;
disengaging the protrusion of the resilient latch from the cavity;
pulling the housing away from the bracket; and
disengaging the lip from the gap in the bottom end portion of the bracket.

17. A method for disengaging a housing of a connector module from a bracket as claimed in claim 16, wherein the bracket is mounted to a mounting structure by straps.

18. A method for disengaging a housing of a connector module from a bracket as claimed in claim 16, wherein the housing defines an interior region with a connector jack disposed in the interior region, the connector jack being accessible through one of the connector openings in the front wall of the housing.

19. A method for disengaging a housing of a connector module from a bracket as claimed in claim 16, wherein the second end of the housing defines a dimple, the dimple providing access to the free end portion of the resilient latch of the bracket to disengage the protrusion from the cavity.

20. A method for disengaging a housing of a connector module from a bracket as claimed in claim 16, wherein the housing includes a plurality of identification areas disposed on the front wall of the housing.
